(19) United States
(12) Patent Application Publication
(10) Pub. No.: US 2026/0204111 A1
(43) Pub. Date: Jul. 16, 2026

(54) SYSTEMS AND METHODS FOR FACILITATING OPTIMAL TRAILER WEIGHT DISTRIBUTION

(71) Applicant: Ford Global Technologies, LLC, Dearborn, MI (US)

(72) Inventors: Abel Hurtado, Mexico City (MX); Eder Guzman, Toluca (MX); Enrique Denicia, Miguel Hidalgo (MX)

(73) Assignee: Ford Global Technologies, LLC, Dearborn, MI (US)

(21) Appl. No.: 19/023,754

(22) Filed: Jan. 16, 2025

(51) Int. Cl. G07C 5/08; B60Q 1/50; G07C 5/00

(52) U.S. Cl. CPC G07C 5/0825; B60Q 1/543; G07C 5/008; G07C 5/0833

(57) ABSTRACT

A vehicle connected to a trailer is disclosed. The vehicle may include a first measurement unit and a processor. The first measurement unit may measure a vehicle orientation. The processor may obtain a first input from the first measurement unit, and a second input from a second measurement unit configured to measure a trailer orientation. Based on the first input and the second input, the processor may calculate an inclination angle between a hitch and a trailer tongue. The vehicle may be connected to the trailer via the hitch and the trailer tongue. The processor may further determine that a load distribution on the trailer is not equivalent to a predefined optimal weight distribution based on the inclination angle, and output a notification responsive to determining that the load distribution on the trailer is not equivalent to the predefined optimal weight distribution.

### TECHNICAL FIELD

The present disclosure relates to vehicles, and more specifically to systems and methods for facilitating an optimal weight distribution on a trailer connected to a vehicle.

### BACKGROUND

Trailers are used in transportation industry to transport goods across long distances. Trailers are typically attached to towing vehicles that drive the trailers. Trailers have cargo space in which users may store goods to be transported. Trailers can also be in the form of Recreation Vehicles (RVs) that may not necessarily be used to transport cargo, but may be used for recreational activities.

In some cases, a trailer may begin to sway side to side while being towed by a towing vehicle, also known as “trailer swaying”. The trailer and the vehicle may become unstable when the trailer sways. The most common causes of trailer swaying are improper weight distribution, tight turns, steep roads, high-speed driving, a tall truck passing, crosswinds, over-steering, etc.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts an example view of a vehicle sagging due to improper weight distribution in a trailer, in accordance with the present disclosure.

FIG. 3 depicts a first example of a notification output by a vehicle in accordance with the present disclosure.

FIG. 4 depicts a second example of a notification output by a vehicle in accordance with the present disclosure.

FIG. 5 depicts a flow diagram of an example method for facilitating an optimal weight distribution on a trailer in accordance with the present disclosure.

### DETAILED DESCRIPTION

### Overview

The present disclosure describes a system and method to optimally distribute a load on a trailer connected to a vehicle, before the start of a journey. Optimally distributing the load on the trailer before the start of the journey prevents or minimizes trailer swaying while the trailer is being towed by the vehicle. In some aspects, the vehicle may be connected to the trailer via a vehicle hitch and a trailer tongue.

The system may include a first measurement unit that may detect/measure an inclination/orientation of the vehicle, and a second measurement unit that may detect/measure an inclination/orientation of the trailer. The first measurement unit and the second measurement unit may enable the system to estimate the load distribution on the trailer. In some aspects, the system may use a first input obtained from the first measurement unit and a second input obtained from the second measurement unit to calculate an inclination angle between the hitch and the trailer tongue. The inclination angle may indicate the load distribution on the trailer. For instance, when the inclination angle between the hitch and the trailer tongue is equivalent to zero degrees (i.e., the hitch and the trailer tongue are aligned), the load on the trailer may be optimally distributed. On the other hand, when the inclination angle between the hitch and the trailer tongue is not equivalent to zero degrees (i.e., the hitch and the trailer tongue are not aligned), the load on the trailer may not be optimally distributed.

In some aspects, the first measurement may include one or more inertial measurement units (IMUs), which may be disposed on a vehicle tail light. The second measurement may include one or more inertial measurement units (IMUs), which may be disposed on a trailer bed. As an example, a first IMU may be disposed on the trailer bed towards a trailer front portion, and a second IMU may be disposed on the trailer bed towards a trailer back portion. In further aspect, an IMU may be positioned at a trailer center portion.

In some aspects, responsive to calculating the inclination angle, the system may determine whether the load distribution on the trailer is equivalent to a predefined optimal weight distribution or not, based on the inclination angle. Responsive to determining that the load distribution on the trailer is not equivalent to the predefined optimal weight distribution, the system may output a first notification. On the other hand, the system may output a second notification when the load distribution on the trailer may be equivalent to the predefined optimal weight distribution.

In some aspects, to determine whether the load distribution on the trailer is equivalent to the predefined optimal weight distribution, the system may “estimate” a current load distribution on the trailer based on the first input and the second input obtained from the first measurement unit and the second measurement unit (or the calculated inclination angle). The system may further fetch information associated with the predefined optimal weight distribution from a vehicle memory, and then compare the predefined optimal weight distribution with the estimated load distribution. Based on the comparison, the system may determine whether the load distribution on the trailer is equivalent to the predefined optimal weight distribution or not.

The system may output the notification (including the first notification or the second notification described above) via a vehicle component. In some aspects, to output the first/second notification, the system may actuate the vehicle tail lights to provide a predetermined visual indicator to the vehicle operator external to the vehicle. For instance, the system may cause the tail light to illuminate in a first color (e.g., green color) when the load distribution on the trailer is equivalent to the predefined optimal weight distribution. On the other hand, the system may actuate the tail light to illuminate in a second color (e.g., red color) when the load distribution on the trailer is not equivalent to the predefined optimal weight distribution. In further aspects, the system may output the first/second notification on a vehicle Human Machine Interface (HMI), which may enable the vehicle operator to determine whether the load distribution on the trailer is equivalent to the predefined optimal weight distribution while sitting inside the vehicle.

The present disclosure discloses a system and method to prevent/minimize trailer swaying. Specifically, the present disclosure discloses a system and method to enable the vehicle operator to optimally distribute the weight on the trailer before the start of the journey. The system may provide indication/notification to the vehicle operator via different vehicle components, which may enable the vehicle operator to view the load distribution status conveniently, thereby enhancing user experience of operating the trailer.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

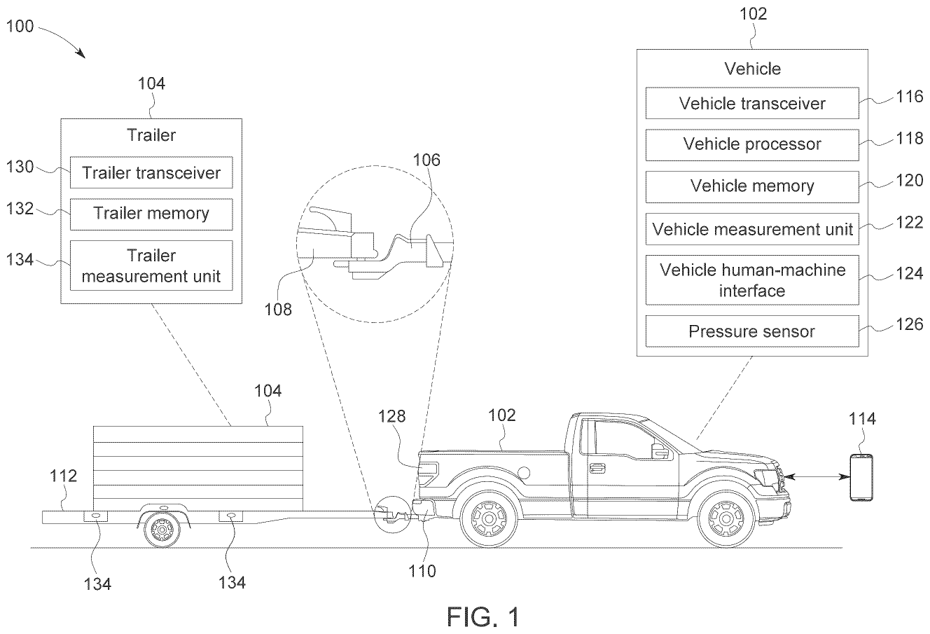

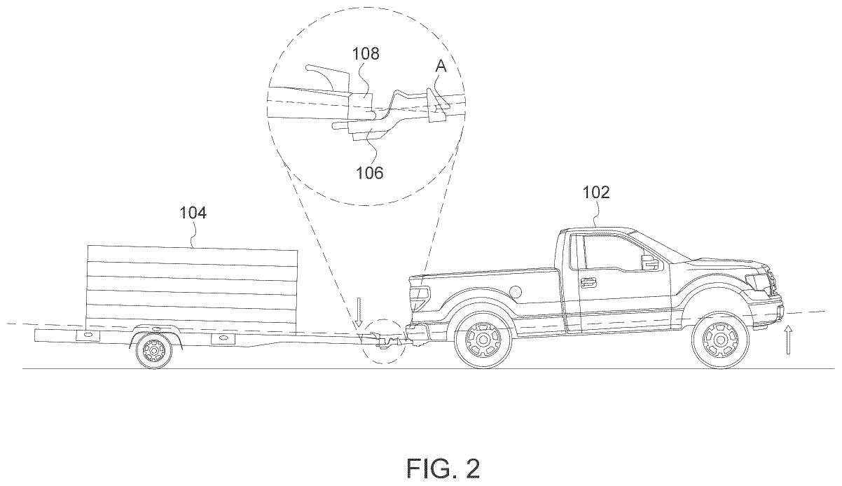

FIG. 1 depicts an example environment 100 in which techniques and structures for providing the systems and methods disclosed herein may be implemented. While describing FIG. 1, references will be made to FIGS. 2-4.

The environment 100 may include a towing vehicle 102 (or a vehicle 102) connected to a trailer 104. The trailer 104 may be connected to a vehicle rear portion, as shown in FIG. 1. In particular, the trailer 104 may be connected to the vehicle rear portion by using mechanical, electrical and/or magnetic fasteners. The trailer 104 may be a cargo trailer that may be used to transport goods, or may be a Recreational Vehicle (RV). In some aspects, the trailer 104 may operate (e.g., move on a road network) when the vehicle 102 “pulls” the trailer 104 from the vehicle rear portion.

The vehicle 102 may take the form of any passenger or commercial vehicle such as a car, an off-road vehicle, a work vehicle, a crossover vehicle, a van, a minivan, a taxi, a bus, a truck, etc. Further, the vehicle 102 may be a manually driven vehicle, and/or may be configured to operate in partially or fully autonomous mode, and may include any powertrain such as a gasoline engine, one or more electrically-actuated motor(s), a hybrid system, etc.

In some aspects, the vehicle 102 may include a hitch 106 at a vehicle rear portion, and the trailer 104 may include a trailer tongue 108 that may extend from a trailer front portion. The hitch 106 may removably couple with the trailer tongue 108 to enable connection between the trailer 104 and the vehicle 102. The hitch 106 may be any hitch including, but not limited to, a drawbar hitch, a weight distributing hitch, a fifth wheel hitch, a gooseneck hitch, and/or the like. In some aspects, the hitch 106 may be disposed on or extend from a vehicle bed 110. The trailer tongue 108 may extend from the trailer front portion, such as from a front portion of a trailer bed 112.

In some aspects, the vehicle 102 and the trailer 104 may be communicatively coupled with each other via one or more networks (not shown). The network(s), as described herein, illustrates an example communication infrastructure in which the connected devices discussed in various embodiments of this disclosure may communicate. The network(s) may be and/or include the Internet, a private network, public network or other configuration that operates using any one or more known communication protocols such as transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In addition, the vehicle 102 may be communicatively coupled with a user device 114 via the network. The user device 114 may be associated with a vehicle operator (not shown). The user device 114 may be, for example, a mobile phone, a laptop, a computer, a tablet, or any other similar device with communication capabilities.

The vehicle 102 may include a plurality of units including, but not limited to, a vehicle transceiver 116, a vehicle processor 118, a vehicle memory 120, a vehicle measurement unit 122, a vehicle Human Machine Interface (HMI) 124, a pressure sensor 126, a tail light 128, and/or the like.

The vehicle transceiver 116 may transmit/receive information, data, instructions, etc. to/from one or more external devices via the network. For example, the vehicle transceiver 116 may transmit/receive information data, instructions, etc. to/from the trailer 104 and the user device 114 via the network. In addition, the vehicle transceiver 116 may receive information/inputs from vehicle 102 components such as the HMI 124, the vehicle measurement unit 122 (and/or other vehicle sensors), and/or the like. Further, the vehicle transceiver 116 may transmit notifications/command signals to the vehicle 102 components such as the HMI 124, the tail light 128, etc.

The vehicle processor 118 may be in communication with one or more memory devices in communication with the respective computing systems (e.g., the vehicle memory 120 and/or one or more external databases not shown in FIG. 2). The vehicle processor 118 may utilize the vehicle memory 120 to store programs in code and/or to store data for performing aspects in accordance with the disclosure. The vehicle memory 120 may be a non-transitory computer-readable medium or memory storing a trailer load distribution management program code. The vehicle memory 120 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the vehicle memory 120 may store information associated with a predefined optimal weight distribution on the trailer 104. The predefined optimal weight distribution may indicate how the load on the trailer 104 should be distributed to prevent trailer swaying. In an exemplary aspect, the predefined optimal weight distribution may indicate that over half weight (e.g., 60% of the trailer load weight) should be disposed towards the trailer front portion, and less than half weight (e.g., 40% of the trailer load weight) should be disposed towards the trailer back portion. In some aspects, the trailer 104 may not whip around or sway while being towed by the vehicle 102 when the load distribution on the trailer 104 is equivalent to the predefined optimal weight distribution. The vehicle memory 120 may obtain the information associated with the predefined optimal weight distribution from a vehicle/trailer manufacturer, a vehicle operator, a fleet manager (if the vehicle 102 is part of a vehicle fleet), and/or the like.

The vehicle measurement unit 122 may detect/measure a vehicle orientation associated with the vehicle 102 in three-dimensional space. In some aspects, the inputs from the vehicle measurement unit 122 may be used to determine the occurrence of vehicle sagging. Vehicle sagging refers to a situation in which a vehicle portion sags or sits lower than it should be (e.g., when a vehicle back portion is lower than the vehicle front portion, as shown in an example view depicted in FIG. 2). In some aspects, the vehicle sagging occurs when a distance between a vehicle portion (e.g., a rear/back portion of the vehicle bed 110) and the ground decreases compared to manufacturer specifications, which may cause vehicle misalignment. In some aspects, the vehicle sagging may occur when the load distribution on the trailer 104 is not equivalent to the predefined optimal weight distribution. For instance, when the load on the trailer 104 is mostly towards the trailer front portion, the trailer tongue 108 may apply more downward pressure on the hitch 106, due to which the vehicle back portion (e.g., vehicle rear suspension) may receive more weight/force, causing the vehicle back portion to sag and the vehicle front portion to lift, as shown in FIG. 2. When the vehicle sagging occurs, an inclination angle “A” between the hitch 106 and the trailer tongue 108 may not be equivalent to zero degrees, as shown in FIG. 2. Stated another way, when the vehicle sagging occurs, a hitch longitudinal axis may not be parallel to a trailer tongue longitudinal axis. The inclination angle “A” may be equivalent to zero degrees when the hitch 106 may be aligned with the trailer tongue 108 (e.g., when the hitch longitudinal axis may be parallel to the trailer tongue longitudinal axis).

In some aspects, the vehicle measurement unit 122 may include one or more inertial measurement units (IMUs) that may detect/measure the vehicle orientation (or vehicle tilt/level) in real-time. In some aspects, the IMUs may be disposed in the tail light 128, or in proximity to the tail light 128. Alternatively, the IMUs may be disposed at any other vehicle portion(s). The IMUs may measure its orientation in three-dimensional space using accelerometer and/or gyroscope. In further aspects, the vehicle 102 may include one or more additional vehicle sensors that may detect vehicle orientation, such as sensors installed in the vehicle's suspension components to measure changes in the suspension's compression. The IMUs (and/or the vehicle sensors) may transmit inputs to the vehicle transceiver 116 periodically (e.g., at a predefined frequency), via the network. The vehicle transceiver 116 may transmit the inputs obtained from the IMUs (and/or the vehicle sensors) to the vehicle processor 118 and/or the vehicle memory 120 for storage purpose.

Similar to the vehicle 102, the trailer 104 may include a plurality of units including, but not limited to, a trailer transceiver 130, a trailer memory 132, a trailer measurement unit 134, and/or the like. The trailer transceiver 130 may transmit/receive information, data, instructions, etc. to/from one or more external devices via the network. For example, the trailer transceiver 130 may transmit/receive information data, instructions, etc. to/from the vehicle 102 and the user device 114 via the network. The trailer memory 132 may be similar to the vehicle memory 120, and may store the inputs measured by the trailer measurement unit 134 as “trailer information”.

The trailer measurement unit 134 may be similar to the vehicle measurement unit 122. The trailer measurement unit 134 may measure a trailer orientation/level associated with the trailer 104 in three-dimensional space. When the trailer 104 is properly leveled, the inclination angle “A” between the hitch 106 and the trailer tongue 108 may be equivalent to zero degrees (e.g., the hitch longitudinal axis may be parallel to the trailer tongue longitudinal axis, as shown in FIG. 1). The trailer 104 may be leveled when a distance between the trailer bed 112 and the ground at the trailer front portion and the trailer back portion is the same. When the trailer 104 is not properly leveled (e.g., tilted at one side relative to the ground), the inclination angle “A” may not be equivalent to zero degrees (e.g., the hitch longitudinal axis may not be parallel to the trailer tongue longitudinal axis, or the inclination angle between the hitch longitudinal axis and the trailer tongue longitudinal axis is different from zero/180 degrees). In some aspects, the inclination angle “A” may be equivalent to zero degrees when the load distribution on the trailer 104 is equivalent to the predefined optimal weight distribution, and the inclination angle “A” may not be equivalent to zero degrees when the load distribution on the trailer 104 is not equivalent to the predefined optimal weight distribution.

In some aspects, the trailer measurement unit 134 may include one or more IMUs. The IMUs may be disposed anywhere on the trailer 104. In some aspects, the IMUs may be disposed on the trailer bed 112. For example, a first IMU may be disposed towards the trailer front portion and a second IMU may be disposed towards the trailer back portion. In further aspect, an IMU may be positioned at a trailer center portion.

The trailer measurement unit 134 may transmit the measured inputs described above to the trailer transceiver 130 periodically (e.g., at a predefined frequency). Further, the trailer transceiver 130 may transmit the measured inputs to the trailer memory 132 for storage purpose, and/or to the vehicle transceiver 116.

A person ordinarily skilled in the art may appreciate that the architecture of the vehicle 102 and the trailer 104 may omit certain vehicle and trailer units and/or computing modules. It should be readily understood that the vehicle 102 and the trailer 104 depicted in FIG. 1 is an example of a possible implementation according to the present disclosure, and thus, it should not be considered limiting or exclusive.

In operation, the vehicle operator may attach the trailer 104 to the vehicle 102 by coupling the hitch 106 to the trailer tongue 108. When the trailer 104 may be attached to the vehicle 102, the vehicle transceiver 116 may receive inputs from the vehicle measurement unit 122 (or first measurement unit) and the trailer measurement unit 134 (or second measurement unit), via the network. In some aspects, the vehicle transceiver 116 may receive the inputs before the vehicle 102 starts to tow the trailer 104. In an exemplary aspect, the vehicle transceiver 116 may receive first input associated with the vehicle orientation from the vehicle measurement unit 122, and second input associated with the trailer orientation from the trailer measurement unit 134. The vehicle transceiver 116 may transmit the first input and the second input to the vehicle processor 118, via the network.

The vehicle processor 118 may obtain the first input and the second input from the vehicle measurement unit 122 and the trailer measurement unit 134, via the vehicle transceiver 116. Responsive to obtaining the first input and the second input, the vehicle processor 118 may fetch the information associated with the predefined optimal weight distribution from the vehicle memory 120, and determine whether the load distribution on the trailer 104 is equivalent to the predefined optimal weight distribution based on the first input and the second input and the information fetched from the vehicle memory 120. The vehicle processor 118 may output a first notification responsive to determining that the load distribution on the trailer 104 is not equivalent to the predefined optimal weight distribution. Alternatively, the vehicle processor 118 may output a second notification responsive to determining that the load distribution on the trailer 104 is equivalent to the predefined optimal weight distribution.

In some aspects, to determine whether the load distribution on the trailer 104 is equivalent to the predefined optimal weight distribution, the vehicle processor 118 may estimate a current load distribution on the trailer 104 based on the first input and the second input obtained from the vehicle measurement unit 122 and the trailer measurement unit 134. The vehicle processor 118 may fetch the information associated with the predefined optimal weight distribution from the vehicle memory 120, and then compare the predefined optimal weight distribution with the estimated load distribution. Based on the comparison, the vehicle processor 118 may determine whether the load distribution on the trailer 104 is equivalent to the predefined optimal weight distribution.

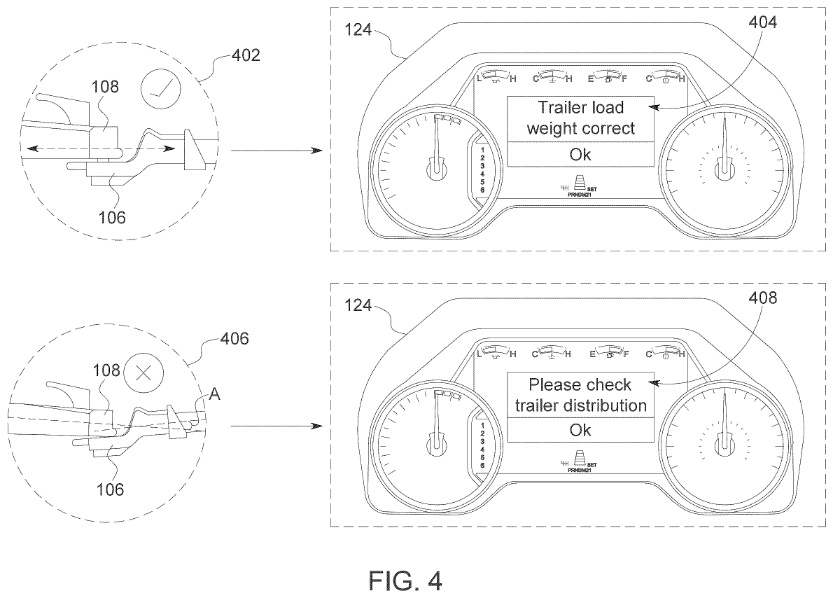

In an example, the vehicle processor 118 may determine or calculate the inclination angle “A” between the hitch 106 and the trailer tongue 108 based on the first input and the second input. Stated another way, the vehicle processor 118 may calculate the inclination angle “A” between the hitch 106 and the trailer tongue 108 based on the measurement of the vehicle orientation and the trailer orientation. The vehicle processor 118 may then estimate the load distribution on the trailer 104 based on the determined inclination angle “A” between the hitch 106 and the trailer tongue 108. For instance, the vehicle processor 118 may estimate/determine that the load is properly distributed on the trailer 104 (or the load distribution on the trailer 104 is equivalent to the predefined optimal weight distribution) when the vehicle processor 118 determines that the inclination angle “A” between the hitch 106 and the trailer tongue 108 is equivalent to zero degrees (as shown in a view 402 of FIG. 4). This is because, when the inclination angle “A” between the hitch 106 and the trailer tongue 108 is equivalent to zero degrees, the trailer 104 and the vehicle 102 may be leveled and not tilted towards any portion. Thus, the vehicle processor 118 may estimate that the load is properly distributed on the trailer 104 when the inclination angle “A” between the hitch 106 and the trailer tongue 108 is equivalent to zero degrees.

On the other hand, the vehicle processor 118 may estimate/determine that the load is improperly distributed on the trailer 104 (or the load distribution on the trailer 104 is not equivalent to the predefined optimal weight distribution) when the vehicle processor 118 determines that the inclination angle “A” between the hitch 106 and the trailer tongue 108 is not equivalent to zero degrees. For instance, when more than half weight of the trailer load is disposed at the trailer back portion, the distance between the trailer bed 112 and the ground towards the trailer back portion may be less than the distance between the trailer bed 112 and the ground towards the trailer front portion. At this position, the inclination angle “A” between the hitch 106 and the trailer tongue 108 may not be equivalent to zero degrees (e.g., the inclination angle “A” between the hitch longitudinal axis and the trailer tongue longitudinal axis may be greater than zero, as shown in a view 406 of FIG. 4). Based on the inclination angle “A”, the vehicle processor 118 may estimate that the more than half weight of the trailer load is disposed at the trailer back portion. Based on such estimation, the vehicle processor 118 may determine that the load distribution on the trailer 104 may not be equivalent to the predefined optimal weight distribution.

In some aspect, the vehicle memory 120 may store a mapping of a plurality of inclination angles (between the hitch 106 and the trailer tongue 108) and corresponding load distributions on the trailer 104. Responsive to determining the inclination angle “A” as described above, the vehicle processor 118 may fetch the mapping from the vehicle memory 120 and estimate the load distribution on the trailer 104 by correlating the mapping with the determined inclination angle. The vehicle processor 118 may then fetch the information associated with the predefined optimal weight distribution from the vehicle memory 120, and then compare the estimated load distribution with the predefined optimal weight distribution. The vehicle processor 118 may then determine whether the load distribution on the trailer 104 is equivalent to the predefined optimal weight distribution based on the comparison.

In additional or alternative aspects, the vehicle processor 118 may first obtain the second input from the trailer measurement unit 134 when the trailer 104 may be attached to the vehicle 102 but not loaded. Responsive to obtaining the second input, the vehicle processor 118 may calculate a baseline trailer position when the trailer 104 may be unloaded. Thereafter, when the trailer 104 is loaded, the vehicle processor 118 may again obtain the second input from the trailer measurement unit 134, and determine a current trailer position/level based on the second input. The vehicle processor 118 may then compare the baseline trailer position with the current trailer position/level. The vehicle processor 118 may determine whether the load distribution on the trailer 104 is equivalent to the predefined optimal weight distribution based on the comparison. For example, the vehicle processor 118 may determine that the load distribution on the trailer 104 may be equivalent to the predefined optimal weight distribution when the current trailer position/level may be equivalent to the baseline trailer position. Alternatively, the vehicle processor 118 may determine that the load distribution on the trailer 104 may not be equivalent to the predefined optimal weight distribution when the current trailer position/level may not be equivalent to the baseline trailer position.

In an exemplary aspect, the vehicle processor 118 may additionally determine a baseline vehicle orientation/alignment before loading by using the IMUs in the tail light 128. Stated another way, the vehicle processor 118 may determine whether the vehicle 102 may be sagging before loading the trailer 104 based on the first input from the vehicle measurement unit 122. The vehicle processor 118 may further determine a current vehicle orientation/alignment by using the IMUs in the tail light 128 when the trailer 104 may be loaded. The vehicle processor 118 may further compare the baseline vehicle orientation/alignment with the current vehicle orientation/alignment, and may determine whether the vehicle 102 may be sagging due to improper load distribution on the trailer 104 based on the comparison. In some aspects, the vehicle processor 118 may use the current vehicle orientation/alignment and the current trailer position/level to calculate the inclination angle “A”.

In further aspects, the vehicle 102 may include the pressure sensor 126 (or load sensor) that may detect pressure/load on the hitch 106, when the trailer 104 may be connected to the vehicle 102 (or when the hitch 106 may be coupled to the trailer tongue 108). The pressure sensor 126 may detect/measure the pressure on the hitch 106 and transmit information/measurements associated with the pressure to the vehicle transceiver 116 at a predefined frequency, via the network. The vehicle transceiver 116 may receive the information and transmit it to the vehicle processor 118. The vehicle processor 118 may obtain the information associated with the pressure, and determine whether the load distribution on the trailer 104 may be equivalent to the predefined optimal weight distribution based on the obtained pressure information. For instance, the vehicle processor 118 may determine that the load distribution on the trailer 104 may not be equivalent to the predefined optimal weight distribution when the pressure on the hitch 106 may be less than a threshold value. This is because the pressure on the hitch 106 is less than the threshold value when the trailer load is more shifted towards the trailer back portion (indicating improper weight distribution on the trailer 104).

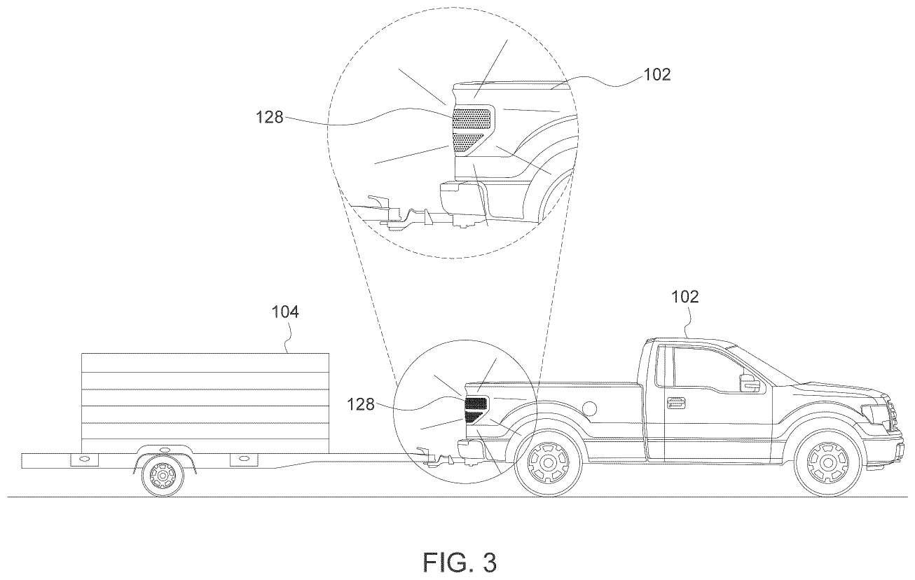

As described above, the vehicle processor 118 may output the first notification responsive to determining that the load distribution on the trailer 104 may not be equivalent to the predefined optimal weight distribution. Alternatively, the vehicle processor 118 may output the second notification responsive to determining that the load distribution on the trailer 104 may be equivalent to the predefined optimal weight distribution. In some aspects, the vehicle processor 118 may output the first/second notification via the tail light 128 (e.g., a left side tail light and/or a right side tail light) to provide a visual indication to the vehicle operator external to the vehicle 102. Specifically, the vehicle processor 118 may actuate the tail light 128, via a vehicle electronic control unit (ECU), to output the first/second notification, as shown in FIG. 3. In some aspects, the vehicle processor 118 may actuate the tail light 128 to provide a predetermined visual indicator. For instance, the vehicle processor 118 may illuminate in a first color (e.g., green color) when the load distribution on the trailer 104 may be equivalent to the predefined optimal weight distribution. In a similar manner, the vehicle processor 118 may actuate the tail light 128 to illuminate in a second color (e.g., red color) when the load distribution on the trailer 104 may not be equivalent to the predefined optimal weight distribution.

Further, in some aspects, the vehicle processor 118 may actuate the tail light 128 to display a predefined visual pattern to output the first/second notification. In an exemplary aspect, the vehicle processor 118 may actuate the tail light 128 to display a first visual pattern to output the first notification, and may actuate the tail light 128 to display a second visual pattern to output the second notification. For instance, the tail light 128 may flash at a first frequency to output the first notification and at a second frequency to output the second notification.

In some aspects, in addition or alternative to illuminating the tail light 128 to output the first/second notification, the vehicle processor 118 may actuate/illuminate a different vehicle component such as another external light (in the same or different manner) of the vehicle 102 to provide a visual indication to the vehicle operator external to the vehicle 102. Examples of such lights are headlights, side markers, etc. In further aspects, the vehicle processor 118 may actuate a vehicle speaker (not shown) to provide an audio indication to the vehicle operator external to the vehicle 102.

In addition or alternatively, the vehicle processor 118 may output the first/second notification on the HMI 124, as shown in FIG. 4, which may enable the vehicle operator to determine whether the load distribution on the trailer 104 is equivalent to the predefined optimal weight distribution or not while sitting inside the vehicle 102. Stated another way, the vehicle processor 118 may output the first/second notification on the HMI 124 so that the vehicle operator may determine whether the trailer 104 is properly loaded, which may enable the vehicle operator to view the loading status while sitting inside the vehicle 102. In some aspects, in this case, the vehicle processor 118 may receive a vehicle operator request to provide a trailer load status, via the HMI 124 (or the user device 114). The vehicle processor 118 may output the first/second notification responsive to obtaining the vehicle operator request.

In some aspects, when the vehicle processor 118 determines that the inclination angle “A” between the hitch 106 and the trailer tongue 108 is equivalent to zero degrees (as shown in the view 402), the vehicle processor 118 may output a notification 404 on the HMI 124. The notification 404 may indicate that the trailer load distribution is correct or the load distribution on the trailer 104 is equivalent to the predefined optimal weight distribution.

In further aspects, when the vehicle processor 118 determines that the inclination angle between the hitch 106 and the trailer tongue 108 is not equivalent to (or greater than) zero degrees (as shown in the view 406), the vehicle processor 118 may output a notification 408 on the HMI 124. The notification 408 may indicate that the trailer load distribution is incorrect or the load distribution on the trailer 104 is not equivalent to the predefined optimal weight distribution.

In further aspects, the vehicle processor 118 may determine a recommendation for optimally distributing load on the trailer 104 based on the first input and the second input, when the vehicle processor 118 determines that the load distribution on the trailer 104 is not equivalent to the predefined optimal weight distribution. In this case, the vehicle processor 118 may output the notification 408 which may include the recommendation for optimally distributing the load on the trailer 104. For instance, the vehicle processor 118 may obtain inputs from the pressure sensor 126, and determine that the pressure on the hitch 106 is less than a threshold value. Responsive to such determination, the vehicle processor 118 may recommend the vehicle operator to distribute/move the trailer load from the trailer back portion to the trailer front portion to optimally distribute the load on the trailer 104.

In further aspects, the vehicle processor 118 may output the first/second notification on the user device 114, via the network, to aid the vehicle operator external to the vehicle 102 to determine whether the trailer 104 is properly loaded. In addition, the vehicle processor 118 may transmit other information to the user device 114 including, but not limited to, the first input and the second input before and after loading the trailer 104, recommendation to distribute the load on the trailer 104, and/or the like.

The vehicle 102 implements and/or performs operations, as described here in the present disclosure, in accordance with the owner manual and safety guidelines. In addition, any action taken by the vehicle operator based on the notifications/recommendations provided by the vehicle 102 should comply with all the rules specific to the location and operation of the vehicle 102 (e.g., Federal, state, country, city, etc.). The notifications/recommendations, as provided by the vehicle 102, should be treated as suggestions and only followed according to any rules specific to the location and operation of the vehicle 102.

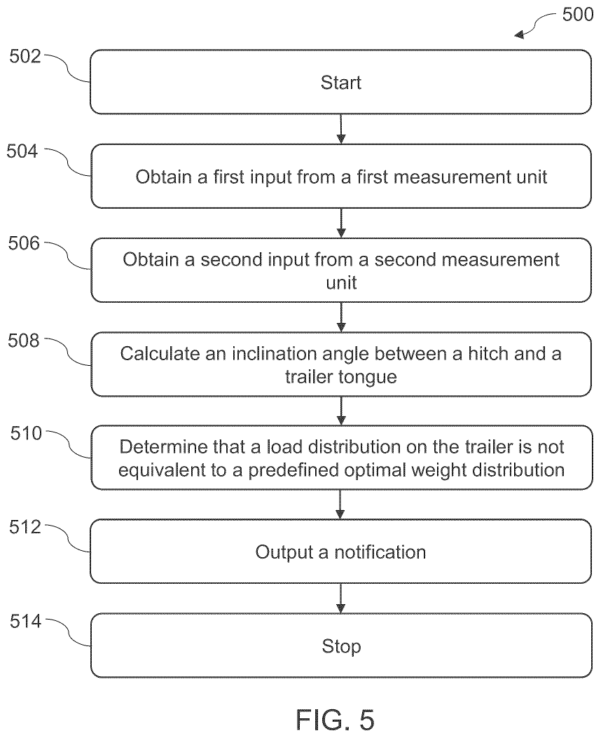

FIG. 5 depicts a flow diagram of an example method 500 for facilitating an optimal weight distribution on the trailer 104 in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

Referring to FIG. 5, at step 502, the method 500 may commence. At step 504, the method 500 may include obtaining, by the vehicle processor 118, a first input from the vehicle measurement unit 122. At step 506, the method 500 may include obtaining, by the vehicle processor 118, a second input from the trailer measurement unit 134.

At step 508, the method 500 may include calculating, by the vehicle processor 118, the inclination angle “A” between the hitch 106 and the trailer tongue 108 based on the first input and the second input. At step 510, the method 500 may include determining, by the vehicle processor 118, that the load distribution on the trailer 104 is not equivalent to the predefined optimal weight distribution based on the inclination angle “A”. At step 512, the method 500 may include outputting, by the vehicle processor 118, a first notification responsive to determining that the load distribution on the trailer 104 is not equivalent to the predefined optimal weight distribution. Alternatively, the vehicle processor 118 may output a second notification responsive to determining that the load distribution on the trailer 104 is equivalent to the predefined optimal weight distribution.

At step 514, the method 500 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle connected to a trailer, the vehicle comprising:
a first measurement unit configured to measure a vehicle orientation; and
a processor configured to:
obtain a first input from the first measurement unit;
obtain a second input from a second measurement unit configured to measure a trailer orientation, wherein the second measurement unit is disposed on the trailer;
calculate an inclination angle between a hitch and a trailer tongue based on the first input and the second input, wherein the vehicle is connected to the trailer via the hitch and the trailer tongue;
determine that a load distribution on the trailer is not equivalent to a predefined optimal weight distribution based on the inclination angle; and
output a first notification responsive to determining that the load distribution on the trailer is not equivalent to the predefined optimal weight distribution.

2. The vehicle of claim 1, wherein the second measurement unit is an inertial measurement unit.

3. The vehicle of claim 1, wherein the second measurement unit is disposed at a trailer bed.

4. The vehicle of claim 1, wherein the first measurement unit is an inertial measurement unit.

5. The vehicle of claim 4, wherein the first measurement unit is disposed in a vehicle tail light.

6. The vehicle of claim 1 further comprising a memory configured to store an information associated with the predefined optimal weight distribution, wherein the processor determines that the load distribution on the trailer is not equivalent to the predefined optimal weight distribution based on the information.

7. The vehicle of claim 1, wherein the processor is further configured to:
determine that the inclination angle between the hitch and the trailer tongue is not equivalent to zero degrees; and
determine that the load distribution on the trailer is not equivalent to the predefined optimal weight distribution responsive to determining that the inclination angle between the hitch and the trailer tongue is not equivalent to zero degrees.

8. The vehicle of claim 1 further comprising a vehicle sensor configured to measure a pressure on the hitch.

9. The vehicle of claim 8, wherein the processor is further configured to:
obtain inputs from the vehicle sensor; and
determine that the load distribution on the trailer is not equivalent to the predefined optimal weight distribution based on the inputs obtained from the vehicle sensor.

10. The vehicle of claim 1, wherein the processor is further configured to:
estimate the load distribution on the trailer based on the first input and the second input; and
determine that the load distribution on the trailer is not equivalent to the predefined optimal weight distribution based on the estimation of the load distribution.

11. The vehicle of claim 1, wherein the processor is configured to output the first notification on a vehicle Human-Machine Interface.

12. The vehicle of claim 1, wherein the processor is configured to output the first notification on a user device.

13. The vehicle of claim 1, wherein the processor is configured to output the first notification via a vehicle component.

14. The vehicle of claim 13, wherein the vehicle component is a vehicle tail light.

15. The vehicle of claim 13, wherein the vehicle component is a vehicle speaker.

16. The vehicle of claim 1, wherein the processor is further configured to:
determine a recommendation for distributing load on the trailer based on the first input and the second input; and
output the first notification that comprises the recommendation for distributing the load on the trailer.

17. The vehicle of claim 1, wherein the processor is further configured to:
determine that the inclination angle between the hitch and the trailer tongue is equivalent to zero degrees; and
determine that the load distribution on the trailer is equivalent to the predefined optimal weight distribution responsive to determining that the inclination angle between the hitch and the trailer tongue is equivalent to zero degrees.

18. The vehicle of claim 17, wherein the processor is further configured to output a second notification responsive to determining that the load distribution on the trailer is equivalent to the predefined optimal weight distribution.

19. A method comprising:
obtaining, by a processor, a first input from a first measurement unit configured to measure a vehicle orientation of a vehicle;
obtaining, by the processor, a second input from a second measurement unit configured to measure a trailer orientation, wherein the second measurement unit is disposed on a trailer connected to the vehicle;
calculating, by the processor, an inclination angle between a hitch and a trailer tongue based on the first input and the second input, wherein the vehicle is connected to the trailer via the hitch and the trailer tongue;
determining, by the processor, that a load distribution on the trailer is not equivalent to a predefined optimal weight distribution based on the inclination angle; and
outputting, by the processor, a notification responsive to determining that the load distribution on the trailer is not equivalent to the predefined optimal weight distribution.

20. A non-transitory computer-readable medium storing computer-executable instructions which when executed by one or more processors result in performing operations comprising:
obtaining a first input from a first measurement unit configured to measure a vehicle orientation of a vehicle;
obtaining a second input from a second measurement unit configured to measure a trailer orientation, wherein the second measurement unit is disposed on a trailer connected to the vehicle;
calculating an inclination angle between a hitch and a trailer tongue based on the first input and the second input, wherein the vehicle is connected to the trailer via the hitch and the trailer tongue;
determining that a load distribution on the trailer is not equivalent to a predefined optimal weight distribution based on the inclination angle; and
outputting a notification responsive to determining that the load distribution on the trailer is not equivalent to the predefined optimal weight distribution.
